(19) United States
(12) Patent Application Publication
(10) Pub. No.: US 2010/0331008 A1
(43) Pub. Date: Dec. 30, 2010

(54) Methods and systems for providing user location information in telecommunications networks

(75) Inventor: Pranil Vaidya, Aurora, IL (US)

Correspondence Address: HARNESS, DICKEY & PIERCE, P.L.C., P.O. BOX 8910, RESTON, VA, 20195, US

(73) Assignee: Alcatel-Lucent USA Inc.

(21) Appl. No.: 12/458,084

(22) Filed: Jun. 30, 2009

(51) Int. Cl. H04W 64/00; H04B 7/216

(52) U.S. Cl. 455/456.1; 370/342

(57) ABSTRACT

Example networks include a network-level user location information database that stores user location information for all network users over several points in time from one or more network-level hosts. Example networks may also include a processor and display connected to the database. Example methods include accessing and storing user location information in a database over several points in time in order to create a network-wide user location log. The user location information may be correlated with geographical images to create user location maps and related graphics. Example methods may further include performing data analysis on the user location log to gather trend and predictive data for network traffic.

### BACKGROUND

1. Field

Example embodiments generally relate to systems and methods of telecommunications networks, applications and services associated therewith, and user location information in such networks.

2. Description of Related Art

FIG. 1 is an illustration of a conventional wireless network architecture. As shown in FIG. 1, individual users of a wireless network 10 may communicatively connect via a mobile station 15, such as a cellular telephone, to one or more base transceiver stations (BTS) 20. Data, including both control- and content-related data, may be sent and received between the BTS 20 and the mobile station 15. One or more BTSs 20 may be communicatively connected to a radio network controller (RNC) 25 in conventional wireless network 10. Typically, several BTSs 20 in a single geographic area may connect to a single RNC 25. The RNC 25 may transmit data from the BTS 20 further “up” the wireless network 10, that is, further removed from mobile stations 15, and may further enable passing-off mobile stations 15 between BTSs 20, as the mobile stations 15 move through particular geographic areas. RNCs 25 may further coordinate data transmission throughout the wireless network 10, including determining resource priority and transmission type between mobile stations 15 and BTSs 20.

Information regarding number of users/mobile stations 15 connected to a particular BTS 20 at any given time is conventionally accessible at individual BTS sites. Available information includes number of users connected, a mobile station ID, length of connection time, and Quality of Service metrics for users being served by a particular BTS 20. Network operators may periodically poll individual BTSs 20 in order to gather data regarding total network usage and/or network traffic data.

The mobile stations 15, BTSs 20, and RNCs 25 may all be part of a radio access network (RAN) 50. A telecommunications provider may operate one or more RANs 50 in providing telecommunications services in a variety of forms and areas. RAN 50 typically utilizes one or more communications standards uniformly throughout the RAN 50, including, for example Evolution-Data Optimized (EVDO), Code Division Multiple Access (CDMA), Universal Mobile Telecommunications System (UMTS), WiFi, etc., for the various forms of communications between each of its components.

RAN 50 may be communicatively connected to a Packet Data Serving Node (PDSN) 60 via RNCs 25, in a CDMA network, for example. PDSN 60 may provide a variety of services to RAN 50, including internet access, operational data, and/or network applications to the RAN 50. PDSN 60 may connect through a Foreign Agent 70 and/or Home Agent 75, which may include conventional servers, routers, and/or other internet access devices, to a wireless network services server (WNSS) 80, which may be provided to RAN 50 through PDSN 60. WNSS 80 may be one or more network provider-owned servers in a central or decentralized location(s) and may include, for example, hardware and/or software providing an internet browser, email management application, software downloading programs, etc.

PDSN 60 may be further connected to a subscription/services management host, such as an Authentication, Authorization, and Accounting (AAA) host 40, which may serve as a gatekeeper to the various applications and data available through PDSN 60. AAA host 40 may reside on one or more network provider-owned servers in a central location co-located with PDSN 60, a single remote location, or several remote and/or co-located locations. AAA host 40 may include one or more servers 45, which may provide subscriber- and application-specific data and govern user access to WNSS 80 through PDSN 60. The host 40 may include an home subscriber server (HSS) database 46 and/or home location register (HLR) database 47 that maintain a listing of active users 15 network-wide for the purpose of matching subscription services with particular users based on their subscription data, log-on status, geographic location, etc. The user information is conventionally transferred to HSS/HLR databases 46/47 through the network from users' 15 registration messages when user equipment is powered on, at regular intervals, during service changes, etc., whereupon the HSS/HLR 46/47 updates the data based on any received changes.

Thus, HSS database 46 and/or HLR database 47 may include several pieces of real-time information regarding active users 15, including, for example, a serving GPRS support node (SGSN) number, mobile switching center (MSC) number, powered-on status, BTS 20 association and location, length of association, handoff status, a mobile station ID, call placement and services usage, etc. With this data, AAA host 40 may, for example, monitor individual usage of WNSS 80 and provide appropriate billing data for each user 15 of network 10 based on logon status and subscription information.

### SUMMARY

Example embodiments include systems and methods of providing and otherwise handling user information within telecommunications networks, including wireless telecommunications networks. Example networks include a network-level user location information database that accesses and stores user location information for all network users over several points in time. The user location information may be accessed from one or more network-level hosts. Example networks may also include a processor and display connected to the database and configured to access, analyze, print and/or display the user location information.

Example methods include accessing and storing user location information in a database over several points in time in order to create a network-wide user location log containing historic location information for all users of the network. The user location information may be correlated with geographical images to create user location maps, which may be shown in sequence to create an animation of user location and movement. Example methods may further include performing data analysis on the user location log to gather trend and predictive data for network traffic.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a conventional wireless telecommunications network.

FIG. 2 is an illustration of an example embodiment wireless telecommunications network.

FIG. 3 is a flow chart of an example method useable with example embodiment wireless telecommunications networks.

### DETAILED DESCRIPTION

Detailed illustrative embodiments of example embodiments are disclosed herein. However, specific structural and functional details disclosed herein are merely representative for purposes of describing example embodiments. The example embodiments may, however, be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the language explicitly indicates otherwise. It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially and concurrently or may sometimes be executed in the reverse order, depending upon the functionality/acts involved.

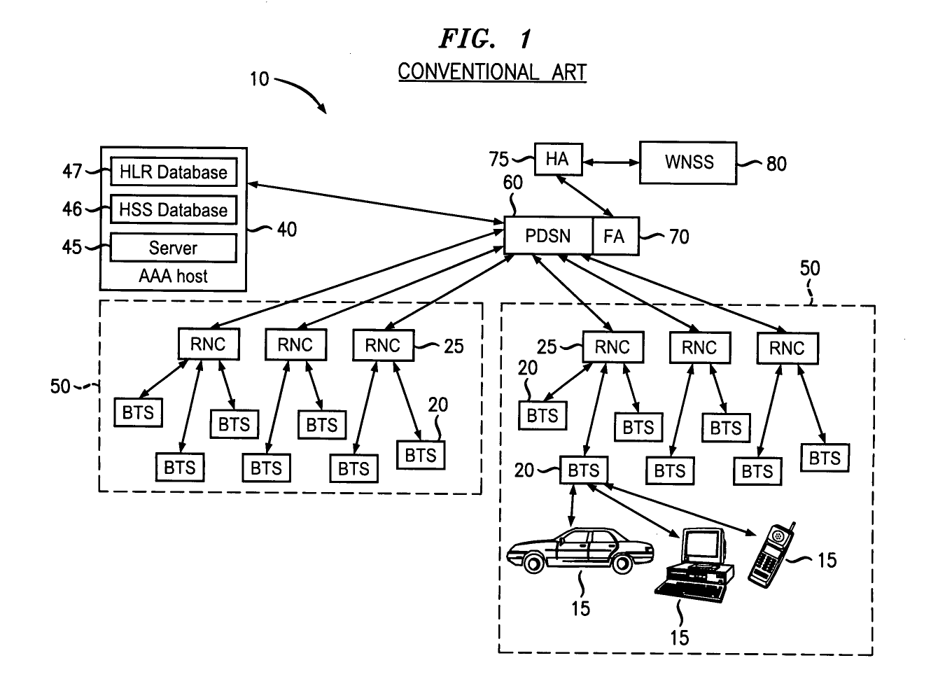

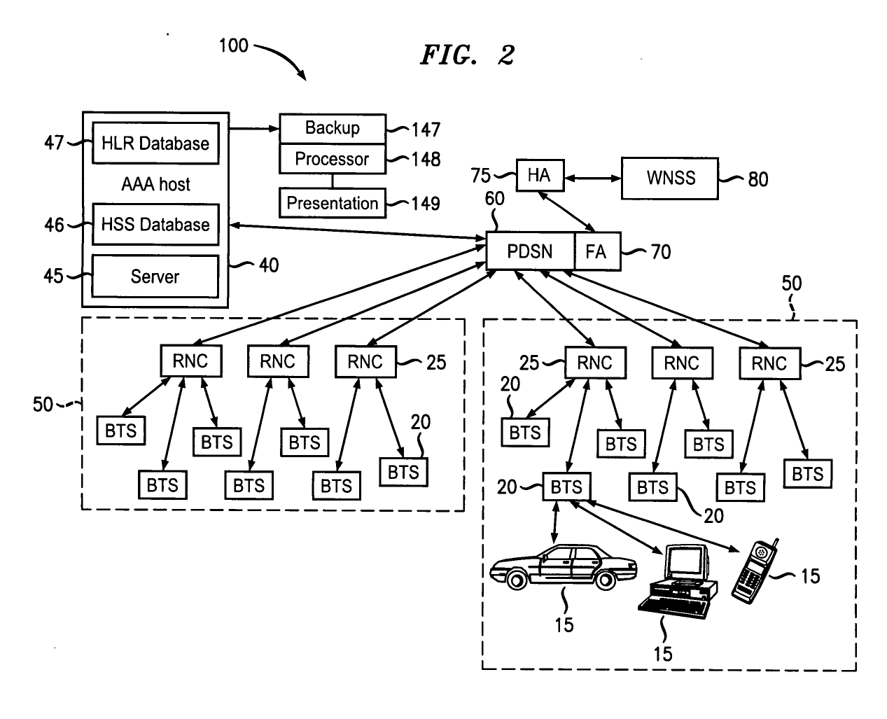

FIG. 2 is an illustration of an example embodiment wireless network 100 that may permit monitoring and prediction of user traffic conditions with consumption of fewer resources and/or greater scope than conventional networks. The network 100 shown in FIG. 2 may have several similar features to conventional wireless networks described in FIG. 1, with like numbering indicating redundant features. Descriptions of redundant features between FIG. 1 and FIG. 2 are omitted for the sake of brevity.

Example embodiment wireless network 100 may be any type of telecommunications network, operating on or compatible with any number of conventional communications standards and operating protocols, including, for example, EVDO, CDMA, WiFi, UMTA, WiMax, etc. It is understood by those familiar with telecommunications networks that some elements may differ or be unique to different operating protocols. For example, PDSN 60 shown in FIG. 2 may be unique to a CDMA network, but other known network signals and architecture, including SGSN/GGSN and/or MSC/VLR, may be substituted for PDSN 60 based on the network type. Although various elements of FIG. 2 are shown connected by similar arrows, it is understood that any and various types of communicative connection may be indicated by such arrows between connected elements, including, for example, a wireless connection, a fiber-optic cable connection, etc., that permits the exchange of information therebetween. Similarly, although FIG. 2 illustrates mobile stations 15 as user equipment, it is understood that the terms “user,” “mobile station,” and “user equipment” are interchangeable terms for the mobile stations 15.

Example embodiment wireless network 100 includes at least one user data backup 147 communicatively connected to a network-level host, such as AAA host 40. User data backup 147 may be any known data storage device, including a remotely-accessible server or group of servers, for example. Although only a single user data backup 147 is shown in FIG. 2, it is understood that several, discreet backups 147 may be communicatively connected to network 100 via a network-level host. Similarly, although only a single AAA host 40 is shown in FIG. 2, it is understood that several AAA hosts 40 and/or other network-level hosts including a home location register (HLR) database 47, home subscriber server (HSS) database 46, and/or other similar databases may be all connected to a single or multiple user data backups 147.

A processor 148 or other processing device such as a computer may be associated with and/or connected to the backup 147. Processor 148 may be configured to read, write, process, analyze, etc. data from backup 147, based on appropriate programming. A presentation device 149 may be communicatively connected to processor 148 and/or backup 147 to display, print, animate, and/or otherwise present data output from either. Although not shown in FIG. 2, each of presentation device 149, processor 148, and backup 147 may be further connected to additional external input/output sources from which additional data, applications, user requests, etc. may be input or output.

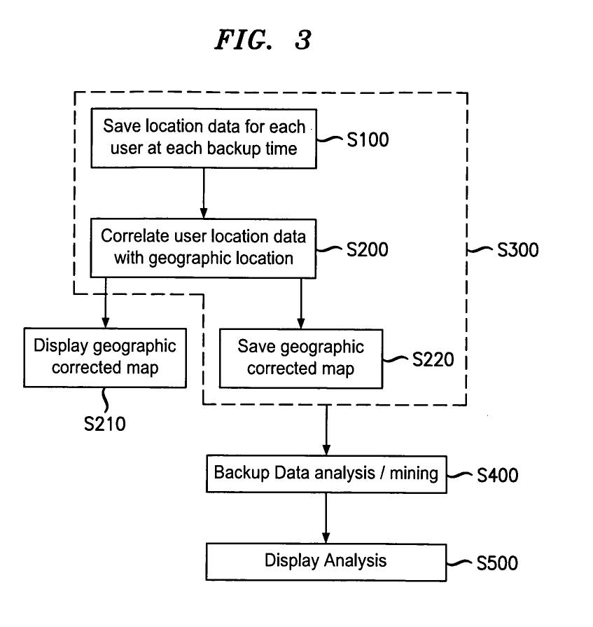

Example methods are now described with reference to the example network 100 shown in FIG. 2 and described above. Example methods include transferring user location information from a network-level HLR database 47, HSS database 46, or the like, to backup 147, as shown in step S100 of FIG. 3. The user information in network-level databases may be electronically transferred to backup 147 through known data transfer means, including TCP/IP protocol, for example. If data is collected from multiple network-level hosts, a data verification and redundancy check may be performed on the user data to ensure accuracy when stored in backup 147.

User location information may include any information conventionally stored in real-time in network-level databases such as HLR database 47, HSS database 46, or the like, including user/mobile station 15 identification information, associated BTS 20 location, a location area ID, a serving GPRS support node (SGSN) number, mobile switching center (MSC) number, etc. The user location information may be stored on backup 147 in any desired format. For example, the user location information data may be written to backup 147 in step S100 in a database format, with an entry for each user, each collection time, and/or etc.

Step S100 may be independently repeated any number of times at any frequency—the user location information may be transferred to backup 147 in near real-time, at desired intervals, and/or on-demand. The user location information for all users 15 network-wide may be stored for each time step S100 is executed, creating lengthy and robust historic user location information records for each user at several points in time on backup 147. This historic network-wide data is referred to as a network-wide user location log. Further, because each user may require only several bytes to effectively store all user location information, it may be possible to store the user location log in a single file on backup 147.

Example methods may further include analysis and display of the user location log from backup 147 for all users 15 in a particular network 100. For example, in step S200 processor 148 may correlate the user location information with a longitude/attitude and/or zip code for each user from a known location list or outside data source. Processor 148 may then plot each user on a geographical display based on the user location information, so as to provide an accurate map of all users of network 100 to the network operator. In step S210, the created map maybe output on presentation device 149 in response to an operator command, and/or, in step S220, the map may be stored in the user location log on backup 147 or stored on another data storage device connected to processor 148.

Alternatively, during the correlation step S200, processor 148 may screen out users not within a specific geographic location, so as to provide a map of only the specific geographic location and a subset of all users within the specific geographic location, such as a particularly dense usage area and/or an area being evaluated for network service expansion/termination. The geographic location may be predefined or a network operator may provide the location to processor 148.

The correlation and mapping of step S200 may be executed and saved in steps S200 and S220 after each backup in step S100 and/or at other desired intervals. For example, several maps geographically displaying all network-wide users for several time points may be created and saved in conjunction with the raw user location information saved on backup 147.

Through the continuous execution of steps S100, S200, and/or S220, a network-wide user location log, further including historic raw and/or graphic location data for all users network-wide, can be generated and saved to server 147 in step S300. It is understood that, although step S300 includes steps S100, S200, and S220 in sequence, each of these steps may be performed independently and/or repetitively, with other intervening steps not shown, such that a network-wide user location log, including user location information and/or mapping of this information for each user at several desired points in time, is saved on backup 147 in step S300.

Because network-wide user location log may be stored in a single or relatively few locations on backup 147, example methods may further include complex data analysis of network-wide traffic over desired periods of time, while accessing data from a single source or even a single local file. In step S400, processor 148 may access the network-wide user location log on backup 147, or a portion thereof, and analyze the log based on user input or programming. For example, in step S400, processor 148 may access stored geographic correlated maps over an input or predefined time interval and display the maps on presentation device 149 serially so as to produce an animation of network user location over time displayed in step S500. The animation may show user movement and density for the entire network, or a portion thereof. Data from the network-wide user location log on backup 147 may be accessed based on date ranges and screened by geographic location or other user data, so as to provide maps or animation based on user preferences and data stored in the network-wide user location log.

Or, for example, based on the network-wide user location log stored on backup 147, processor 148 may calculate an average user density over a time interval and area unit. For example, a user may provide the processor 148 with a date range of August 1-August 31 of the current year, an area unit of a square kilometer, and a geographic range of the Chicago metropolitan area, and processor 148 may access corresponding user data, calculate the average user density per square mile in the Chicago metropolitan area, and display the results on presentation device 149 in step S500. The results displayed in step S500 may be, for example, a map with color coding assigned to each square kilometer showing average user density in that square kilometer. It is understood that other date ranges, such as every first Monday of a month, every July 4 over the past 10 years, weekdays from 4:30 pm to 6:30 pm, etc., and that other locations, such as zip codes, governmental boundaries, network demarcations, etc. may be used, depending on the analysis desired.

Complex data analysis may be performed in step S400. For example, processor 148 may perform trending and prediction of user traffic patterns based on input criteria. For example, a user may request a chart of daily average number of users for a given BTS 20 for each day of the past month, and processor 148 may access all necessary data from the network-wide user location log on backup 147, perform the necessary calculations and formatting, and display a chart of day versus average user number per day for the requested BTS 20 in step S500. Trend lines may be added and displayed through known recursion and fitting techniques to predict future usage of the requested BTS 20. Alternatively, for example, processor 148 may compile a list of the most increasingly-used BTSs 20 for a given time period, correlate changes in user location to most common traffic (network usage) routes for certain times of the day, predict a number of user handoffs within a given zip code on a future day, etc., and display the results for any of these example calculations in graphical or numeric form in step S500 on presentation device 149.

It is understood that a wide variety of analyses and graphing functions, beyond what has been described above by way of example, may be performed in step S400 with access to the network-wide user location log on backup 147, created and accessible through the use of example networks and methods. Further, although information is displayed, printed, or otherwise presented on a presentation device 149 in step S500, it is understood that results of analysis in step S400 may be stored in backup 147 or transmitted to and used in other locations not shown in FIG. 3.

Because a network-wide user location log containing historic user locations, BTS associations, hand-offs, and/or other location information for the entire network 100 may be stored in a single, network-level location and coupled to a processing device, example networks and methods may provide accurate, comprehensive network traffic data and data analysis. Network operators may thus have access to traffic prediction and other traffic analysis of their choosing in a relatively fast and streamlined manner, without having to repetitively collect data from multiple BTSs 20 and successfully aggregate the potentially overlapping BTS data before analyzing the data.

Based on the data and analysis provided by example methods, network operators may plan operations and allocate resources in a manner that serves the most users. For example, BTS 20 outages may be planned at times of predicted minimal usage, network coverage may be expanded along extrapolated user traffic vectors, additional customer service availability may be planned for predicted times of network saturation, etc.

Example embodiments and methods thus being described, it will be appreciated by one skilled in the art that example embodiments may be varied through routine experimentation and without further inventive activity. Variations are not to be regarded as departure from the spirit and scope of the exemplary embodiments, and all such modifications as would be obvious are intended to be included within the scope of the following claims.

What is claimed is:

1. A telecommunications network comprising:
at least one radio area network including at least one base transceiver;
at least one network-level host communicatively connected to a plurality of RANs, the at least one network-level host configured to store user location information for users in the network at a current point in time; and
at least one user data backup configured to store the user location information from the at least one network-level host over a plurality of points in time.

2. The network of claim 1, wherein the network is a code division multiple access network.

3. The network of claim 1, wherein the at least one network-level host is one of a home location register database and a home subscriber server.

4. The network of claim 1, wherein the user data includes at least one of a mobile station identification number, associated base station location, a location area identification number, a serving GPRS support node number, and a mobile switching center number.

5. The network of claim 1, further comprising:
at least one processor connected to the at least user data backup, the at least one processor configured to access and process the user location information;
at least one presentation device connected to the processor, the at least one presentation device configured to present the processed user location information.

6. A method of handling user location information in a telecommunications network, the method comprising:
accessing user location information from a network-level host;
storing the user location information on a user data backup; and
repeating the accessing and storing over several points in time so as to create a network-wide user location log.

7. The method of claim 6, further comprising:
correlating, with a processor, the user location information with geographic data so as to create a mapping of locations of network users; and
storing the mapping on the user data backup.

8. The method of claim 7, wherein the repeating step further includes repeating the correlating the user location information step and the storing the mapping step so as to create a network-wide user location log with geographic data.

9. The method of claim 8, further comprising:
presenting data from the network-wide user location log.

10. The method of claim 9, wherein the displaying is responsive to and formatted according to a user request.

11. The method of claim 6, further comprising:
presenting data from the network-wide user location log.

12. The method of claim 11, wherein the displaying is responsive to and formatted according to a user request.

13. The method of claim 6, wherein the network is a code division multiple access network.

14. The method of claim 6, wherein the at least one network-level host is one of a home location register database and a home subscriber server.

15. The method of claim 6, wherein the user data includes at least one of a mobile station identification number, associated base station location, a location area identification number, a serving GPRS support node number, and a mobile switching center number.

16. The method of claim 6, further comprising:
performing data analysis, with a processor, on the network-wide user location log.

17. The method of claim 16, wherein the data analysis includes generating a network traffic prediction based on trends calculated from the network-wide user location log.

18. The method of claim 16, further comprising:
presenting the data analysis.

19. The method of claim 18, wherein the displaying is responsive to and formatted according to a user request.

20. A method of handling user location information in a telecommunications network, the method comprising:
storing user location information for network users at a plurality of points in time on a single network-level backup so as to create a network-wide user location log.
